(19) United States
(12) Patent Application Publication
(10) Pub. No.: US 2024/0123813 A1
(43) Pub. Date: Apr. 18, 2024

(54) ROTOR ALIGNMENT COMPENSATION WITH FRICTION MATERIAL

(71) Applicant: Schaeffler Technologies AG & Co. KG, Herzogenaurach (DE)

(72) Inventors: Jordan Geiser, Massillon, OH (US); Peter Burke, Charlotte, NC (US); Michael Hodge, Creston, OH (US); Patrick Lindemann, Wooster, OH (US)

(73) Assignee: Schaeffler Technologies AG & Co. KG, Herzogenaurach (DE)

(21) Appl. No.: 17/966,975

(22) Filed: Oct. 17, 2022

(51) Int. Cl. B60K 6/26; B60K 6/387

(52) U.S. Cl. CPC B60K 6/26; B60K 6/387; B60K 2006/262

(57) ABSTRACT

A generator module for a vehicle includes a housing arranged for fixing to an engine block of a combustion engine, a stator, fixed in the housing, a rotor, rotatable relative to the stator, a hub fixed to the rotor and arranged for fixing to a crankshaft of the combustion engine, a ring gear carrier fixed to the hub, a intermediate plate connected to the ring gear carrier by a first flexible element, a rotor carrier plate fixed to the rotor and connected to the intermediate plate by a second flexible element, and a first friction material segment disposed axially between the intermediate plate and the rotor carrier plate. In an example embodiment, the first friction material segment is a first friction material ring. In an example embodiment, the generator module also includes a ring gear fixed to the ring gear carrier.

### TECHNICAL FIELD

The present disclosure relates generally to a generator module, and more specifically to a generator module with rotor alignment compensation with friction material.

### BACKGROUND

Flexible connections for generator modules are known. One example is shown and described in commonly-assigned United States Patent Application Publication No. 2022/0299067 titled RADIALLY COMPLIANT CONNECTION to Lindemann et al., hereby incorporated by reference as if set forth fully herein.

### SUMMARY

Example aspects broadly comprise a generator module for a vehicle including a housing arranged for fixing to an engine block of a combustion engine, a stator, fixed in the housing, a rotor, rotatable relative to the stator, a hub fixed to the rotor and arranged for fixing to a crankshaft of the combustion engine, a ring gear carrier fixed to the hub, a intermediate plate connected to the ring gear carrier by a first flexible element, a rotor carrier plate fixed to the rotor and connected to the intermediate plate by a second flexible element, and a first friction material segment disposed axially between the intermediate plate and the rotor carrier plate. In an example embodiment, the first friction material segment is a first friction material ring. In an example embodiment, the generator module also includes a ring gear fixed to the ring gear carrier.

In some example embodiments, the intermediate plate has a first radial wall, the rotor carrier plate has a second radial wall, and the first friction material segment is fixed to a one of the first radial wall or the second radial wall and contacts the other one of the first radial wall or the second radial wall. In an example embodiment, the first friction material segment is at least partially radially aligned with the stator. In some example embodiments, the first radial wall is a first radially outer radial wall, the second radial wall is a second radially outer radial wall, and the first friction material segment is fixed to a one of the first radially outer radial wall or the second radially outer radial wall and contacts the other of the first radially outer radial wall or the second radially outer radial wall.

In some example embodiments, the generator module also includes a second friction material segment. The intermediate plate includes a third radially outer radial wall, radially aligned and axially offset from the first radially outer radial wall, the ring gear carrier includes a fourth radially outer radial wall, and the second friction material segment is fixed to a one of the third radially outer radial wall or the fourth radially outer radial wall and contacts the other one of the third radially outer radial wall or the fourth radially outer radial wall. In an example embodiment, the first friction material segment and the second friction material segment are disposed radially outside of the stator. In an example embodiment, the first friction material segment and the second friction material segment are radially aligned and axially offset from one another.

In some example embodiments, the generator module also includes a third friction material segment and a retaining ring fixed to the ring gear carrier. The rotor carrier plate includes a fifth radially outer radial wall, radially aligned and axially offset from the second radially outer radial wall, the retaining ring includes a sixth radially outer radial wall, and the third friction material segment is fixed to a one of the fifth radially outer radial wall or the sixth radially outer radial wall and contacts the other one of the fifth radially outer radial wall or the sixth radially outer radial wall. In an example embodiment, the first friction material segment, the second friction material segment, and the third friction material segment are radially aligned and axially offset from one another. In an example embodiment, the retaining ring is at least partially axially aligned with the stator.

In an example embodiment, the generator module also includes a fourth friction material segment. The intermediate plate includes a first radially inner radial wall, the rotor carrier plate includes a second radially inner radial wall, and the fourth friction material segment is fixed to a one of the first radially inner radial wall or the second radially inner radial wall and contacts the other one of the first radially inner radial wall or the second radially inner radial wall. In an example embodiment, the rotor includes a rotor carrier with a first cylindrical portion and an annular portion, and a plurality of rotor segments arranged on the first cylindrical portion. The rotor carrier plate includes a connecting portion disposed axially between the plurality of rotor segments and the annular portion.

In some example embodiment, the generator module also includes a bearing. The rotor includes a rotor carrier with a first cylindrical portion, the housing includes a second cylindrical portion, and the bearing is disposed radially between the first cylindrical portion and the second cylindrical portion to radially and axially position the rotor relative to the housing. In an example embodiment, the bearing is a double row angular ball bearing. In an example embodiment, the generator module also includes a backing plate fixed to the hub. The ring gear carrier is fixed to the hub axially between the hub and the backing plate.

### BRIEF DESCRIPTION OF THE DRAWINGS

FIG. 1 illustrates a cross-sectional view of a generator module according to an example aspect of the present disclosure.

FIG. 2 illustrates a detail view of area 2 in FIG. 1.

FIG. 3 illustrates a detail view of area 3 in FIG. 1.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

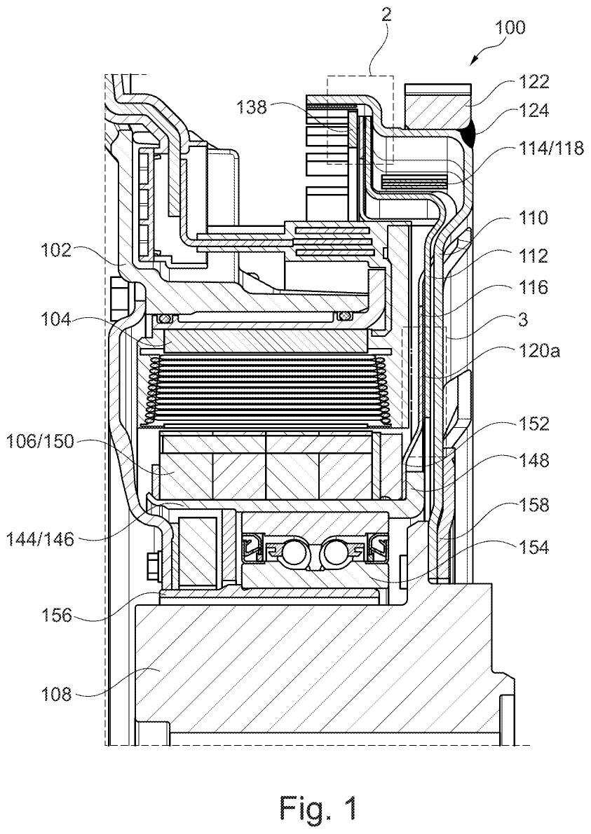

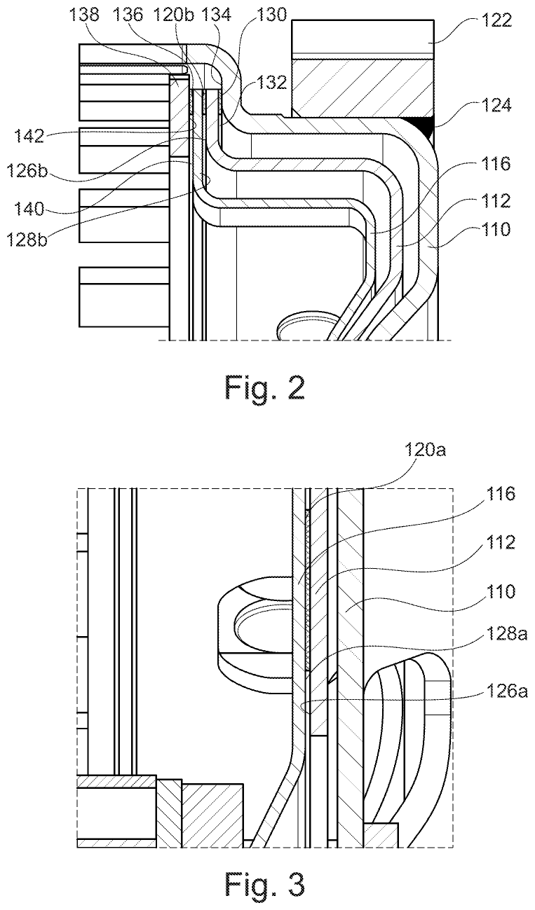

The following description is made with reference to FIGS. 1-3. FIG. 1 illustrates a cross-sectional view of generator module 100 according to an example aspect of the present disclosure. FIG. 2 illustrates a detail view of area 2 in FIG. 1. FIG. 3 illustrates a detail view of area 3 in FIG. 1. Generator module 100 for a vehicle (not shown) includes housing 102 arranged for fixing to an engine block (not shown) of a combustion engine (not shown), stator 104, fixed in the housing, rotor 106, rotatable relative to the stator and hub 108 fixed to the rotor and arranged for fixing to a crankshaft (not shown) of the combustion engine. Module 100 also includes ring gear carrier 110 fixed to the hub, intermediate plate 112 connected to ring gear carrier 110 by flexible element 114, rotor carrier plate 116 fixed to the rotor and connected to intermediate plate 112 by flexible element 118, and friction material segment 120 disposed axially between plates 112 and 114.

Configuration of plates 110, 112 and 116 is similar to that shown and described in commonly-assigned United States Patent Application Publication No. 2022/0299067 titled RADIALLY COMPLIANT CONNECTION to Lindemann et al., hereby incorporated by reference as if set forth fully herein. Although only one flexible element is shown, it may be considered to be either of flexible elements 114 or 118 as disclosed in the above reference application.

Friction material segment 120 may have any number of configurations. For example, segment 120 may be a single segment or a plurality of segments distributed about a circumference. Segment 120 may be a full friction material ring as shown in FIG. 1, for example. Module 100 also includes ring gear 122 fixed to ring gear carrier 110 by weld 124, for example. Ring gear 122 may be engaged with a starter gear (not shown) to rotate the crankshaft to start the engine, for example.

Intermediate plate 112 includes radial wall 126, rotor carrier plate 116 includes radial wall 128, and friction material segment 120 is fixed to one of radial wall 126 or 128 and contacts the other of radial wall 126 or 128. That is, the segment is bonded to one of the walls by an adhesive or other fastening means and the walls are arranged so that the segment makes contact with the nonbonded wall. As shown in FIG. 1, for example, friction material segment 120a is at least partially radially aligned with the stator. By radially aligned, we mean that a line running normal to the radial direction passes through both the segment and the stator. In other words, at least a portion of the segment and the stator share a common radial dimension.

Radial wall 126b is a radially outer radial wall and radial wall 128b is a radially outer radial wall. That is, walls 126b and 128b are arranged at a radially outer portion of plates 112 and 116, respectively. Friction material segment 120b is fixed to one of radial wall 126b or 128b and contacts the other of radial wall 126b or 128b. Generator module also includes friction material segment 130. Intermediate plate 112 includes radially outer radial wall 132, radially aligned and axially offset from radially outer radial wall 126b, and ring gear carrier 110 includes radially outer radial wall 134. In other words, walls 126b and 132 are disposed on opposite axial sides of intermediate plate 112. Friction material segment 130 is fixed to one of radial wall 132 or 134 and contacts the other of radial wall 132 or 134. Friction material segments 120b and 130 are disposed radially outside of the stator and radially aligned and axially offset from one another.

Generator module 100 includes friction material segment 136 and retaining ring 138 fixed to ring gear carrier 110. Ring 138 may be a snap ring installed in a groove of ring gear carrier 110, for example, to limit axial displacement of plates 112 and 116 relative to ring gear carrier 110, for example. Rotor carrier plate 116 includes radially outer radial wall 140, radially aligned and axially offset from second radially outer radial wall 128b and the retaining ring includes radially outer radial wall 142. Segment 136 is fixed to one of radial wall 140 or 142, and contacts the other of radial wall 140 or 142. Friction material segments 120b, 130 and 136 are radially aligned and axially offset from one another. Retaining ring 138 is at least partially axially aligned with the stator. By axially aligned, we mean that a line running normal to the axial direction passes through both the retaining ring and the stator. In other words, at least a portion of the retaining ring and the stator share a common axial dimension.

Generator module 100 also includes friction material segment 120a. Intermediate plate 112 includes radially inner radial wall 126a and rotor carrier plate 116 includes radially inner radial wall 128a. Friction material segment 120a is fixed to one of radial wall 126a or 128a and contacts the other of radial wall 128a or 128.

Rotor 106 includes rotor carrier 144 with cylindrical portion 146 and annular portion 148, and rotor segments 150 arranged on cylindrical portion 146. Rotor carrier plate 116 includes connecting portion 152 disposed axially between segments 150 and annular portion 148. Module 100 also includes bearing 154. Housing 102 includes cylindrical portion 156 and the bearing is disposed radially between portions 146 and 156 to radially and axially position the rotor relative to the housing. In the embodiment shown in FIG. 1, the bearing is a double row angular ball bearing. Generator module 100 also includes backing plate 158 fixed to the hub, and ring gear carrier 110 is fixed to the hub axially between the hub and the backing plate.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Generator module
102 Housing
104 Stator
106 Rotor
108 Hub
110 Ring gear carrier
112 Intermediate plate
114 Flexible element (first)
116 Rotor carrier plate
118 Flexible element (second)
120 Friction material segment (first)
120a Friction material segment (first/fourth, inner)
120b Friction material segment (first, outer)
122 Ring gear
124 Weld
126 Radial wall (first, intermediate plate)
126a Radially inner radial wall (first, intermediate plate)
126b Radially outer radial wall (first, intermediate plate)
128 Radial wall (second, rotor carrier plate)
128a Radially inner radial wall (second, rotor carrier plate)
128b Radially outer radial wall (second, rotor carrier plate)
130 Friction material segment (second)
132 Radially outer radial wall (third, intermediate plate)
134 Radially outer radial wall (fourth, ring gear carrier)
136 Friction material segment (third)
138 Retaining ring
140 Radially outer radial wall (fifth, rotor carrier plate)
142 Radially outer radial wall (sixth, retaining ring)
144 Rotor carrier
146 Cylindrical portion (first, rotor carrier)
148 Annular portion (rotor carrier)
150 Rotor segments
152 Connecting portion (rotor carrier plate)
154 Bearing
156 Cylindrical portion (second, housing)
158 Backing plate

What is claimed is:

1. A generator module for a vehicle, comprising:
a housing arranged for fixing to an engine block of a combustion engine;
a stator, fixed in the housing;
a rotor, rotatable relative to the stator;
a hub fixed to the rotor and arranged for fixing to a crankshaft of the combustion engine;
a ring gear carrier fixed to the hub;
a intermediate plate connected to the ring gear carrier by a first flexible element;
a rotor carrier plate fixed to the rotor and connected to the intermediate plate by a second flexible element; and
a first friction material segment disposed axially between the intermediate plate and the rotor carrier plate.

2. The generator module of claim 1 wherein the first friction material segment is a first friction material ring.

3. The generator module of claim 1 further comprising a ring gear fixed to the ring gear carrier.

4. The generator module of claim 1 wherein:
the intermediate plate comprises a first radial wall;
the rotor carrier plate comprises a second radial wall; and
the first friction material segment is fixed to a one of the first radial wall or the second radial wall and contacts the other one of the first radial wall or the second radial wall.

5. The generator module of claim 4 wherein the first friction material segment is at least partially radially aligned with the stator.

6. The generator module of claim 4 wherein:
the first radial wall is a first radially outer radial wall;
the second radial wall is a second radially outer radial wall; and
the first friction material segment is fixed to a one of the first radially outer radial wall or the second radially outer radial wall and contacts the other of the first radially outer radial wall or the second radially outer radial wall.

7. The generator module of claim 6 further comprising a second friction material segment, wherein:
the intermediate plate comprises a third radially outer radial wall, radially aligned and axially offset from the first radially outer radial wall;
the ring gear carrier comprises a fourth radially outer radial wall; and
the second friction material segment is fixed to a one of the third radially outer radial wall or the fourth radially outer radial wall and contacts the other one of the third radially outer radial wall or the fourth radially outer radial wall.

8. The generator module of claim 7 wherein the first friction material segment and the second friction material segment are disposed radially outside of the stator.

9. The generator module of claim 7 wherein the first friction material segment and the second friction material segment are radially aligned and axially offset from one another.

10. The generator module of claim 7 further comprising:
a third friction material segment; and
a retaining ring fixed to the ring gear carrier, wherein:
the rotor carrier plate comprises a fifth radially outer radial wall, radially aligned and axially offset from the second radially outer radial wall;
the retaining ring comprises a sixth radially outer radial wall; and
the third friction material segment is fixed to a one of the fifth radially outer radial wall or the sixth radially outer radial wall and contacts the other one of the fifth radially outer radial wall or the sixth radially outer radial wall.

11. The generator module of claim 10 wherein the first friction material segment, the second friction material segment, and the third friction material segment are radially aligned and axially offset from one another.

12. The generator module of claim 10 wherein the retaining ring is at least partially axially aligned with the stator.

13. The generator module of claim 10 further comprising a fourth friction material segment, wherein:
the intermediate plate comprises a first radially inner radial wall;
the rotor carrier plate comprises a second radially inner radial wall; and
the fourth friction material segment is fixed to a one of the first radially inner radial wall or the second radially inner radial wall and contacts the other one of the first radially inner radial wall or the second radially inner radial wall.

14. The generator module of claim 1 wherein:
the rotor comprises:
a rotor carrier with a first cylindrical portion and an annular portion; and
a plurality of rotor segments arranged on the first cylindrical portion; and
the rotor carrier plate comprises a connecting portion disposed axially between the plurality of rotor segments and the annular portion.

15. The generator module of claim 1 further comprising a bearing, wherein:
the rotor comprises a rotor carrier with a first cylindrical portion;
the housing comprises a second cylindrical portion; and
the bearing is disposed radially between the first cylindrical portion and the second cylindrical portion to radially and axially position the rotor relative to the housing.

16. The generator module of claim 15 wherein the bearing is a double row angular ball bearing.

17. The generator module of claim 1 further comprising a backing plate fixed to the hub, wherein the ring gear carrier is fixed to the hub axially between the hub and the backing plate.
